(19) United States
(12) Patent Application Publication
(10) Pub. No.: US 2015/0350351 A1
(43) Pub. Date: Dec. 3, 2015

(54) Location-Based Ephemerality of Shared Content

(71) Applicant: Facebook, Inc., Menlo Park, CA (US)

(72) Inventor: Yen-Ting Tony Tung, San Jose, CA (US)

(73) Assignee: Facebook, Inc., Menlo Park, CA (US)

(21) Appl. No.: 14/292,541

(22) Filed: May 30, 2014

(51) Int. Cl. H04L 29/08

(52) U.S. Cl. CPC H04L 67/18; H04L 67/306

(57) ABSTRACT

In one embodiment, a method includes receiving a request to share with a first user a content item associated with a second user. A content location for the content item may be determined. A geo-fenced area for the content item may be determined, the geo-fenced area including the content location. The content item may be shared with the first user as requested. If the second user moves to a location outside the geo-fenced area, determination is made of whether the sharing of the content item should be terminated.

### TECHNICAL FIELD

This disclosure generally relates to sharing content through a social network.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

A mobile computing device—such as a smartphone, tablet computer, or laptop computer—may include functionality for determining its location, direction, or orientation, such as a GPS receiver, compass, or gyroscope. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

In particular embodiments, a user of a social-networking system may share a content item with one or more other users of the social-networking system. The content item may be a photo, a video, a sound recording, a post, a text, a message, a link, or any other content that may be shared by a user. When the user shares the content item through the social-networking system, the user or the social-networking system may determine a content location to be associated with the shared content item. The content location may be the location where the content was created, the location where the content was shared, the location of a particular user on the social-networking system, or any other suitable location. The content location may be associated with a place. The social-networking system may then create a geo-fence defining a geo-fenced area surrounding the content location. The geo-fence may be defined by a fixed distance from the content location, by the boundaries of the associated place, or any other suitable means of determining a geo-fence. The social-networking system may then determine one or more users to be associated with the content, each of the users having a current location within the geo-fenced area.

In particular embodiments, the social-networking system may receive location updates of a location of the associated users. The social-networking system may compare the updated locations against the geo-fenced area. When an associated user's updated location is determined to be outside the geo-fenced area, the social-networking system may determine if the shared content item should subsequently be expired. Upon determining that the shared content item should be expired, the social-networking system may expire the sharing of the content so that the users on the social-networking system who originally had access to the shared content item no longer have access to the shared content item. The social-networking system may also delete the shared content item from the social-networking system.

In particular embodiments, the shared content item may also have a time-based expiration. The user or the social-networking system may determine a lifetime to be associated with the shared content item, the lifetime comprising a particular time period. If the social-networking system is unable to receive an updated location of the associated users, and the lifetime elapses from the time of sharing, the social-networking system may expire the content based on the time-based expiration.

### BRIEF DESCRIPTION OF THE DRAWINGS

FIG. 1 illustrates an example network environment associated with a social-networking system.

FIG. 2 illustrates an example social graph.

FIG. 3 illustrates an example mobile device.

FIG. 4 illustrates an example of a shared content item.

FIG. 5 illustrates an example method for determining if a shared content item should be expired.

FIGS. 6A-6D illustrate an example of a shared content item with location-based expiration.

FIG. 7 illustrates an example of a geo-fence for an irregular-shaped place.

FIG. 8 illustrates an example method for tracking whether a user has left an irregular-shaped place.

FIGS. 9A-9D illustrate an example of tracking a user with respect to an irregular-shaped place.

FIG. 10 illustrates an example method for determining time-based and location-based expiration of content.

FIG. 11 illustrates an example computer system.

### DESCRIPTION OF EXAMPLE EMBODIMENTS

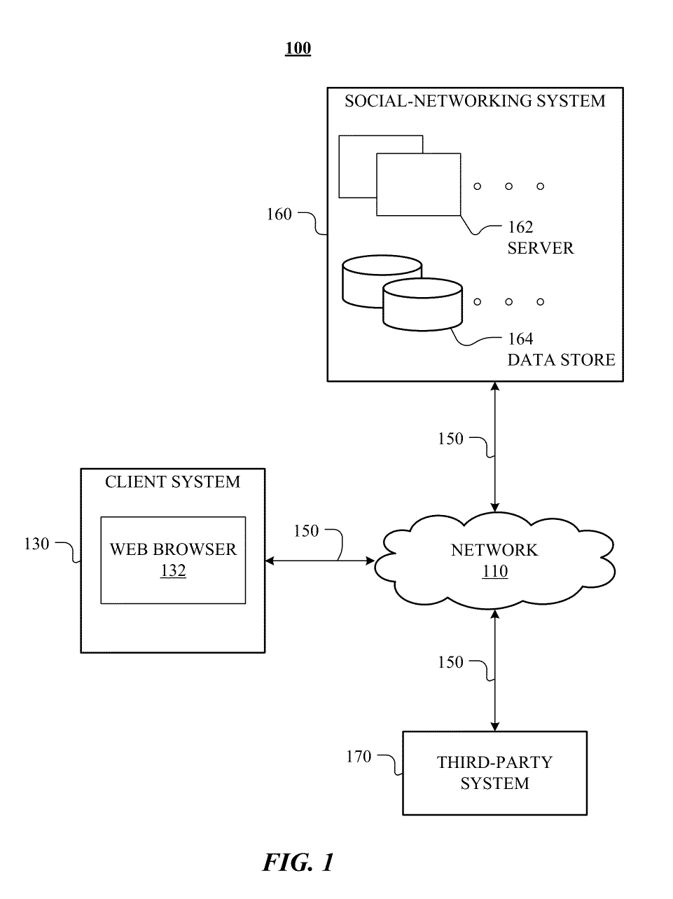

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of client system 130, social-networking system 160, third-party system 170, and network 110, this disclosure contemplates any suitable arrangement of client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client system 130, social-networking systems 160, third-party systems 170, and networks 110.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at client system 130 to access network 110. A client system 130 may enable its user to communicate with other users at other client systems 130.

In particular embodiments, client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 130 may enter a Uniform Resource Locator (URL) or other address directing the web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 160 may be a network-addressable computing system that can host an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. In particular embodiments, social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. Social-networking system 160 may provide users of the online social network the ability to communicate and interact with other users. In particular embodiments, users may join the online social network via social-networking system 160 and then add connections (e.g., relationships) to a number of other users of social-networking system 160 whom they want to be connected to. Herein, the term “friend” may refer to any other user of social-networking system 160 with whom a user has formed a connection, association, or relationship via social-networking system 160.

In particular embodiments, social-networking system 160 may provide users with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which is separate from social-networking system 160 and coupled to social-networking system 160 via a network 110.

In particular embodiments, social-networking system 160 may be capable of linking a variety of entities. As an example and not by way of limitation, social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 160 also includes user-generated content objects, which may enhance a user's interactions with social-networking system 160. User-generated content may include anything a user can add, upload, send, or “post” to social-networking system 160. As an example and not by way of limitation, a user communicates posts to social-networking system 160 from a client system 130. Posts may include data such as status updates or other textual data, location information, photos, videos, links, music or other similar data or media. Content may also be added to social-networking system 160 by a third-party through a “communication channel,” such as a newsfeed or stream.

In particular embodiments, social-networking system 160 may include a variety of servers, sub-systems, programs, modules, logs, and data stores. In particular embodiments, social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 160 may also include suitable components such as network interfaces, security mechanisms, load balancers, failover servers, management-and-network-operations consoles, other suitable components, or any suitable combination thereof. In particular embodiments, social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more client systems 130 or one or more third-party system 170 via network 110. The web server may include a mail server or other messaging functionality for receiving and routing messages between social-networking system 160 and one or more client systems 130. An API-request server may allow a third-party system 170 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of social-networking system 160. A privacy setting of a user determines how particular information associated with a user can be shared. The authorization server may allow users to opt in to or opt out of having their actions logged by social-networking system 160 or shared with other systems (e.g., third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

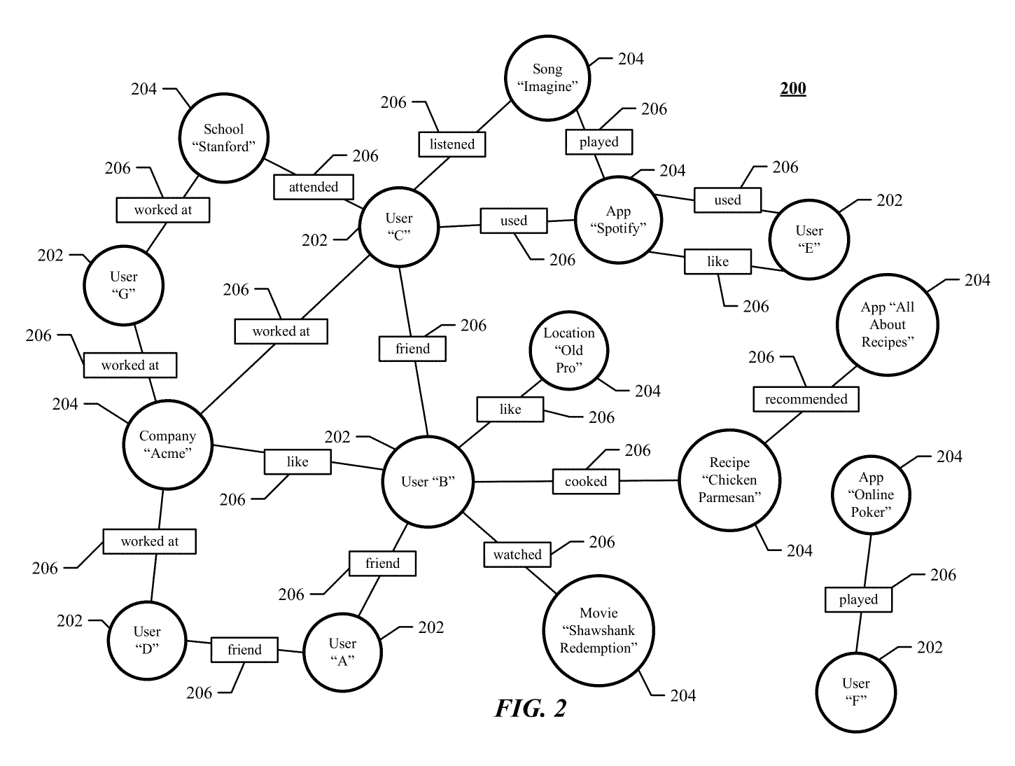

FIG. 2 illustrates example social graph 200. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 2 is shown, for didactic purposes, in a two-dimensional visual map representation. In particular embodiments, a social-networking system 160, client system 130, or third-party system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example and not by way of limitation, a user may be an individual (human user), an entity (e.g., an enterprise, business, or third-party application), or a group (e.g., of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system 130 to send to social-networking system 160 a message indicating the user's action. In response to the message, social-networking system 160 may create an edge (e.g., an “eat” edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, social-networking system 160 may send a “friend request” to the second user. If the second user confirms the “friend request,” social-networking system 160 may create an edge 206 connecting the first user's user node 202 to the second user's user node 202 in social graph 200 and store edge 206 as social-graph information in one or more of data stores 164. In the example of FIG. 2, social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to an edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, social-networking system 160 may create an edge 206 between a user node 202 and a concept node 204 in social graph 200. As an example and not by way of limitation, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to send to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

In particular embodiments, social-networking system 160 may determine a geographic location (hereinafter also simply “location”) of an object (e.g., a user, a concept, or a mobile-client system 130 associated with a user or concept). The location of an object may be identified and stored as a street address (e.g., “1601 Willow Road”), a set of geographic coordinates (latitude and longitude), a reference to another location or object (e.g., “the coffee shop next to the train station”), a reference to a map tile (e.g., “map tile 32”), or using another suitable identifier. In particular embodiments, the location of an object may be provided by a user of an online social network. As an example and not by way of limitation, a user may input his location by checking-in at the location or otherwise providing an indication of his location. As another example and not by way of limitation, a user may input the location of a concept (e.g., a place or venue) by accessing the profile page for the concept and entering the location information (e.g., the stress address) of the concept. In particular embodiment, the location of a mobile-client system 130 equipped with cellular, Wi-Fi, GPS, or other suitable capabilities may be identified with geographic-positioning signals. As an example and not by way of limitation, a mobile-client system 130 may include one or more sensors that may facilitate geo-location functionalities of the system. Processing of sensor inputs by the mobile-client system 130 with one or more sensor devices (for example, processing a GPS sensor signal and displaying in the device's graphical user interface a map of a location corresponding to the GPS sensor signal) may be implemented by a combination of hardware, software, or firmware (or device drivers). Geographic-positioning signals may be obtained by cell tower triangulation, Wi-Fi positioning, or GPS positioning. In particular embodiments, a geographic location of an Internet-connected computer can be identified by the computer's IP address. A mobile-client system 130 may also have additional functionalities incorporating geographic-location data of the device, such as, for example, providing driving directions, displaying a map of a current location, or providing information of nearby points of interest such as restaurants, gas stations, etc. As an example and not by way of limitation, a web browser application on the mobile-client system 130 may access a mapping library (e.g., via a function call) that generates a map containing a GPS location obtained by a device driver interpreting a GPS signal from a GPS sensor, and display the map in the web browser application's graphical user interface. In particular embodiments, the location of a user may be determined from a search history associated with the user. As an example and not by way of limitation, if a particular user has previously queried for objects in a particular location, social-networking system 160 (or search-engine system 170) may assume that the user is still at that particular location. Although this disclosure describes determining the location of an object in a particular manner, this disclosure contemplates determining the location of an object in any suitable manner.

In particular embodiments, social-networking system 160 may maintain a database of information relating to locations. Social-networking system 160 may also maintain meta information about particular locations, such as, for example, photos of the location, advertisements, user reviews, comments, “check-in” activity data, “like” activity data, hours of operation, or other suitable information related to the location. In particular embodiments, a location may correspond to a concept node 204 in a social graph 200 (such as, for example, as described previously or as described in U.S. Pat. No. 8,244,848, which is incorporated by reference herein). Social-networking system 160 may allow users to access information regarding a location using a client application (e.g., a web browser or other suitable application) hosted by a mobile-client system 130. As an example and not by way of limitation, social-networking system 160 may serve webpages (or other structured documents) to users that request information about a location. In addition to user profile and location information, the system may track or maintain other information about the user. As an example and not by way of limitation, social-networking system 160 may support geo-social-networking functionality including one or more location-based services that record the user's location. As an example and not by way of limitation, users may access the geo-social-networking system using a special-purpose client application hosted by a mobile-client system 130 of the user (or a web- or network-based application using a browser client). The client application may automatically access GPS or other geo-location functions supported by the mobile-client system 130 and report the user's current location to the geo-social-networking system. In addition, the client application may support geo-social networking functionality that allows users to “check-in” at various locations and communicate this location to other users. A check-in to a given location may occur when a user is physically located at a location and, using a mobile-client system 130, access the geo-social-networking system to register the user's presence at the location. Social-networking system 160 may automatically check-in a user to a location based on the user's current location and past location data (such as, for example, as described in U.S. Patent Application Publication No. 2012/0233158, which is incorporated by reference herein). In particular embodiments, social-networking system 160 may allow users to indicate other types of relationships with respect to particular locations, such as “like,” “fan,” “worked at,” “recommended,” “attended,” or another suitable type of relationship. In particular embodiments, “check-in” information and other relationship information may be represented in the social graph 200 as an edge 206 connecting the user node 202 of the user to the concept node 204 of the location.

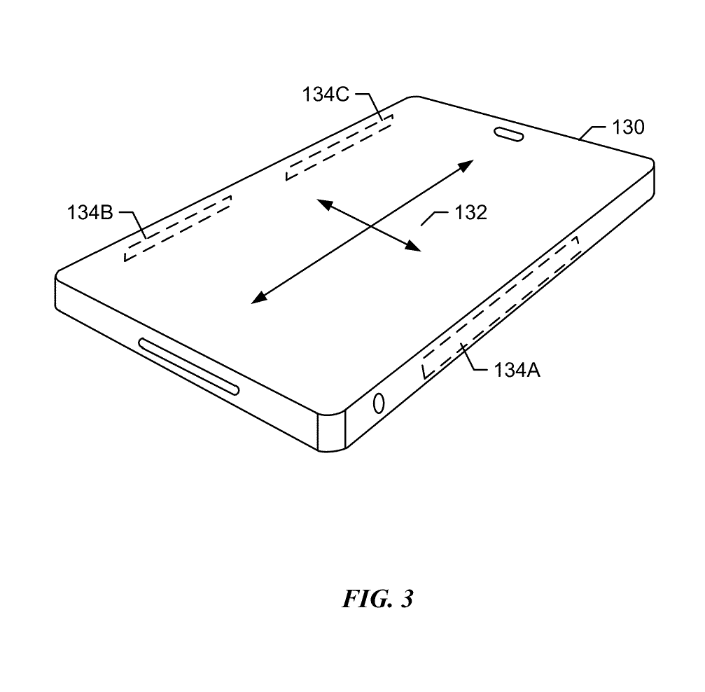

FIG. 3 illustrates an example mobile client system 130. This disclosure contemplates mobile client system 130 taking any suitable physical form. In particular embodiments, mobile client system 130 may be a computing system as described below. As example and not by way of limitation, mobile client system 130 may be a single-board computer system (SBC) (such as, for example, a computer-on-module (COM) or system-on-module (SOM)), a laptop or notebook computer system, a mobile telephone, a smartphone, a personal digital assistant (PDA), a tablet computer system, or a combination of two or more of these. In particular embodiments, mobile client system 130 may have a touch sensor 132 as an input component. In the example of FIG. 3, touch sensor 132 is incorporated on a front surface of mobile client system 130. In the case of capacitive touch sensors, there may be two types of electrodes: transmitting and receiving. These electrodes may be connected to a controller designed to drive the transmitting electrodes with electrical pulses and measure the changes in capacitance from the receiving electrodes caused by a touch or proximity input. In the example of FIG. 3, one or more antennae 134A-B may be incorporated into one or more sides of mobile client system 130. Antennae 134A-B are components that convert electric current into radio waves, and vice versa. During transmission of signals, a transmitter applies an oscillating radio frequency (RF) electric current to terminals of antenna 134A-B, and antenna 134A-B radiates the energy of the applied the current as electromagnetic (EM) waves. During reception of signals, antennae 134A-B convert the power of an incoming EM wave into a voltage at the terminals of antennae 134A-B. The voltage may be transmitted to a receiver for amplification.

In particular embodiments, mobile client system 130 many include a communication component coupled to antennae 134A-B for communicating with an Ethernet or other wire-based network or a wireless NIC (WNIC), wireless adapter for communicating with a wireless network, such as for example a WI-FI network or modem for communicating with a cellular network, such third generation mobile telecommunications (3G), or Long Term Evolution (LTE) network. This disclosure contemplates any suitable network and any suitable communication component 20 for it. As an example and not by way of limitation, mobile client system 130 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As another example, mobile client system 130 may communicate with a wireless PAN (WPAN) (such as, for example, a BLUETOOTH WPAN), a WI-FI network, a WI-MAX network, a cellular telephone network (such as, for example, a Global System for Mobile Communications (GSM), 3G, or LTE network), or other suitable wireless network or a combination of two or more of these. Mobile client system 130 may include any suitable communication component for any of these networks, where appropriate.

In particular embodiments, the communication component coupled to antennae 134A-B mobile client system 130 may be configured to determine location data based on global positioning system (GPS) signals, cellular triangulation, wireless hotspots, or any suitable methods for determining location data. In particular embodiments, the location service of mobile client system 130 may use one or more methods of location determination, such as for example, using the location of one or more cellular towers, crowd-sourced location information associated with a WI-FI hotspot, or a GPS function of mobile client system 130. As an example and not by way of limitation, the application may use GPS data as the primary source of location information depending at least in part on whether mobile client system 130 is able to acquire GPS data within a pre-determined period of time. As another example, if mobile client system 130 is unable to acquire the GPS data within the pre-determined sampling duration, the application may use the location determined using one or more cellular towers or WI-FI hotspots. Although this disclosure describes a location service using particular methods of location determination, this disclosure contemplates a location service using any suitable method or combination of methods of location detection.

In particular embodiments, a user of social-networking system 160 may send a request to share a content item. As an example and not by way of limitation, the user may opt to share a photo, a video, a sound recording, a post, a text, or a link to a web page. In particular embodiments, the user may use a mobile client system 130 associated with that particular user to send the request. As an example and not by way of limitation, sharing may be done by sending a message to another user; posting the content item to a social-networking system; sending a Short Message Service (SMS) message to the user; sending an instant message (IM) to the user; sending a notification to the user; posting a status update on the social-networking system; or sending an e-mail to the user. In particular embodiments, the sharing user may select one or more receiving users who may be permitted to access the shared content item on social-networking system 160. In particular embodiments, the sharing user may select a pre-existing group comprising one or more other users who may be permitted to access the shared content item. In particular embodiments, the sharing user may share the content item publicly on social-networking system 160, where all other users who are authorized to view or access content shared by that particular user may access the content item. This authorization may be determined by one or more privacy settings of the sharing user.

In particular embodiments, the sharing user may append additional information or text to a shared content item. As an example and not by way of limitation, a sharing user may post to social-networking system 160 a photo, and share it along with a text. In particular embodiments, the text appended to the photo may contain information about the photo. As an example and not by way of limitation, the text may contain information relating to one or more persons or places depicted in the photo, a location where the photo was taken, or a date and time when the photo was taken.

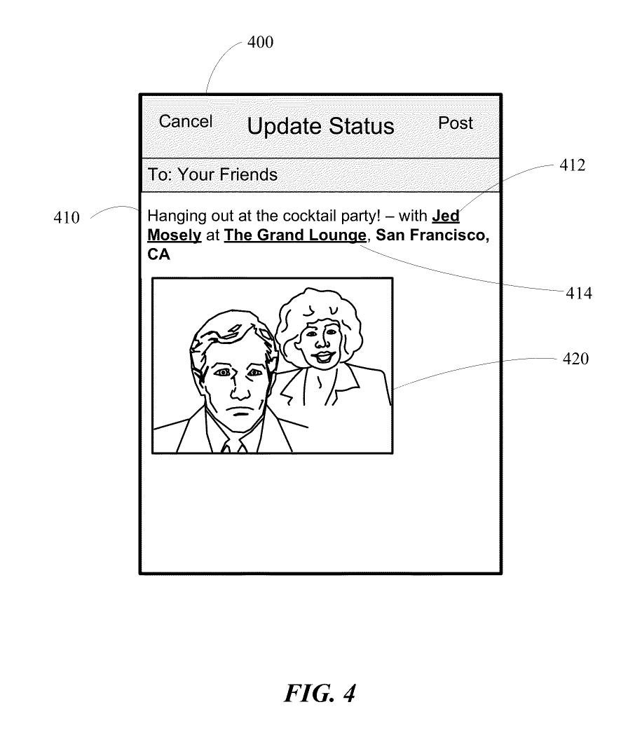

FIG. 4 illustrates an example of a shared content item posted in social-networking system 160. A user of social-networking system 160 may share content through a user interface 400 to post a status update 410. As part of the status update, the user may post content item 420, which in the example of FIG. 4 is a photo. The user may also input text accompanying the content item 420 in the status update 410. This text may contain the name of a person 412. Social-networking system 160 may determine that the name 412 is associated with another user of social-networking system 160. This another user may correspond to a user node 202 on social graph 200. The user node 202 of the particular another user may have a social affinity with respect to a user node 202 corresponding to the user posting status update 410. Social-networking system 160 may then determine that this particular another user is associated with the status update 410, and may additionally determine that this particular another user is also associated with the shared content item 420. In the example of FIG. 4, the user has also input the name of a location or place 414. Social-networking system 160 may determine that the name 414 is associated with a particular location or place which corresponds to an entity node 204 on social graph 200. Social-networking system 160 may determine that the particular place or location associated with the name 414 is also associated with the status update 410 and shared content item 420.

In particular embodiments, social-networking system 160 may determine a content location to be associated with shared content item 420. In particular embodiments, the content location may be the location determined by social-networking system 160 to be the location where shared content item 420 was created. As an example and not by way of limitation, shared content item 420 may contain metadata which comprises a geographic location where shared content item 420 was created. As an example and not by way of limitation, a user may take a photo and share the photo. The photo may comprise location metadata which indicates the geographic location where the photo was taken. This metadata may be automatically appended to the created content item by mobile client system 130, based on the location of mobile client system 130 at the time the content item was created. The location of mobile client system 130 may be determine using methods described above, such as GPS location, cell tower triangulation, Wi-Fi location, or any other suitable method.

In particular embodiments, shared content item 420 may not have any associated location data. As an example and not by way of limitation, shared content item 420 may be a text message created by a user of social-networking system 160, and the text message may not contain metadata comprising a location of where the text message was created. In particular embodiments, a user may share a content item through social-networking system 160 using a mobile client system 130 associated with that user. In particular embodiments, social-networking system 160 may determine a location of mobile client system 130 when the shared content item 420 was shared through social-networking system 160. As an example and not by way of limitation, when a user shares a text message through social-networking system 160, social-networking system 160 may use the location of the user's mobile client system 130 at the time the text message was shared as the content location of the text message.

In particular embodiments, social-networking system 160 may determine for a particular shared content item 420 both a location of where it was created, and a location of where the mobile client system 130 sharing the shared content item 420 was at the time of sharing. As an example and not by way of limitation, a user may post a photo to social-networking system 160 from her mobile client system 130, where the photo contains location metadata comprising a location where it was taken, and social-networking system 160 may have determined where the user's mobile client system 130 was at the time of the post. Social-networking system 160 may select either location as the content location of the photo. In particular embodiments, social-networking system 160 may use a default setting to determine which location to use as the content location. In particular embodiments, the user may have specified her own default setting to use. The default setting may vary based on the type of content being shared. As an example and not by way of limitation, the user may specify that a photo may use a content location of where it was posted from, while also specifying that a video may use a content location of where it was created. In particular embodiments, social-networking system 160 may present an option to the user each time the user shares a content item to specify an individual content location for each shared content item 420.

In particular embodiments, the content location for shared content item 420 may be associated with a place. As an example and not by way of limitation, a user may take a photo at a park, and immediately share the photo through social-networking system 160 from the same location where he took the photo. Social-networking system 160 may access its database of locations and determine that the location metadata associated with the photo and the detected location of the user when the photo was sent to social-networking system 160 correspond to the park. Social-networking system 160 may then determine that the content location of the photo is the park itself In particular embodiments, the user may specify a place to be associated with the shared content item 420. In the example of FIG. 4, the user input of the name of a place or location 414 may correspond to a specific place, rather than a geographic location. In particular embodiments, the user may input a place to be associated with the shared content item separately. As an example and not by way of limitation, social-networking system 160 may present the option to the user, when uploading shared content item 420, to tag it with a particular place or location. Social-networking system 160 may present a list of places based on a current detected location of the user. As another example, social-networking system 160 may present a list of placed based on the user's most-often visited places, or the places that the user has checked-in the most frequently at through social-networking system 160. In particular embodiments, social-networking system 160 may determine a place to be associated with the shared content item based on recent check-in activities of the sharing user. As an example and not by way of limitation, if the user is detected at a location A1, checks-in on social-networking system 160 as being at a particular place B, then a minute later shares a shared content item 420 through social-networking system 160, social-networking system 160 may determine that the user is still at place B, and associate shared content item 420 with place B. As another example, if the user moves to a location A2 which is within a particular threshold distance from location A1, then shares a content item from location A2, social-networking system 160 may determine that the user is still at place B, and associate any shared content item 420 shared from location A2 with place B. In particular embodiments, social-networking system 160 may use previous check-in activities of the user to associate a place with shared content item 420. As an example and not by way of limitation, if the user is at location A1, checks-in to place B, then two weeks later returns to location A1 and shares a content item without checking in to place B, social-networking system 160 may use the previous check-in of the user to determine that if the user is back at location A1, the user is back at place B as well, and any shared content item 420 shared from location A1 should be associated with place B.

In particular embodiments, the content location of a shared content item 420 may be a location of a user of social-networking system 160. Social-networking system 160 may determine that a user's location should be used as the content location based on privacy settings or user preferences of a user, an explicit input by the sharing user when the content item is shared, or by a default setting of social-networking system 160. In particular embodiments, the content location of shared content item 420 may be updated when the location of the user is updated. As an example and not by way of limitation, user Amy may share a photo while in Dolores Park in San Francisco, Calif. social-networking system 160 or Amy may specify that the content location of the photo should be Amy's location, as opposed to the geographic location of Dolores Park, or the place “Dolores Park.” If Amy subsequently moves to a new location in Daly City, Calif., social-networking system 160 may update the content location of the photo to be Amy's new location in Daly City.

In particular embodiments, shared content item 420 may also be associated with one or more users of social-networking system 160. The associated user may be the user sharing the content item, a user tagged in the content item, or any other user specified by the sharing user or by social-networking system 160. In particular embodiments, the associated user may be one or more intended recipients of shared content item 420. As an example and not by way of limitation, user Amy may share a photo depicting herself and user Bob with user Christine. Amy may share the photo with tags for herself and Bob. Social-networking system 160 may determine that the associated users are then Amy, or Amy or Bob, or Christine, based either on user preferences specified by Amy, by user input from Amy at the time of sharing the photo, or by default settings of social-networking system 160. In particular embodiments, social-networking system 160 may only select associated users having a current location at or near the content location for the shared content item. In the example above, Amy make take a photo of herself and Bob at Dolores Park, then subsequently share the photo with Christine tagging both Amy and Bob in the photo. Social-networking system 160 may determine that the content location of the photo should be Dolores Park. If, at the time that Amy shares the photo, Bob has left Dolores Park and is in Oakland, Calif., social-networking system 160 may determine that only Amy should be an associated user, and that Bob cannot be an associated user. Similarly, if Christine is at San Jose, Calif. at the time Amy shares the photo, social-networking system 160 may determine that Christine also cannot be an associated user. In particular embodiments, social-networking system 160 may consider associated users to comprise the users that are tagged in the shared content item 420 by the sharing user at the time the request for sharing is sent to social-networking system 160. In particular embodiments, social-networking system 160 may subsequently add, delete, or change associated users based on subsequent addition or deletion of tags on shared content item 420. As an example and not by way of limitation, Amy may take a photo of herself and Bob, and send it to Bob and Christine, wherein the photo is only tagged with Amy. Social-networking system 160 may initially determine that only Amy is an associated user. Bob may subsequently be added as a tag to the photo by Amy, Bob, or Christine. Upon detecting that Bob has been tagged in the photo, social-networking system 160 may determine if Bob should be added as an associated user, or even if Bob should replace Amy as the sole associated user for this photo.

In particular embodiments, social-networking system 160 may determine the content location of a shared content item 420 first, then determine an associated user. In particular embodiments, social-networking system 160 may determine at least one associated user with a shared content item 420 first, then determine a content location. In particular embodiments, social-networking system 160 may use the current location of an associated user as a factor in determining the content location. As an example and not by way of limitation, user Amy may share a photo of user Bob to user Christine. Social-networking system 160 may first determine that the associated user with this photo should be Bob, then use Bob's current location as the content location for the photo.

In particular embodiments, social-networking system 160 may determine a geo-fenced area to be associated with the shared content item 420. The geo-fence may be based on the content location of the shared content item 420. In particular embodiments, the geo-fence may be based on a predetermined distance from the content location. As an example and not by way of limitation, social-networking system 160 may determine that the geo-fence for a shared photo may comprise a circle with a 1-mile radius centered on the content location of the shared photo. In particular embodiments, the radius of the geo-fence may be determined by a default preference of the sharing user. Social-networking system 160 may provide a number of user preferences to the sharing user. As an example and not by way of limitation, social-networking system 160 may ask the sharing user to define default geo-fence radii based on the type of content being shared, the time or location from where the content item is being shared, the time or location where the content item was created, whether the content item is being shared with one or a few other users, or whether the content item is being publicly shared through social-networking system 160, or any other factors defining the context of sharing the content item.

In particular embodiments, social-networking system 160 may determine a geo-fence radius to be used for a particular shared content item 420, and display that geo-fence radius to the user. The user may choose to accept that radius, or manually input another distance to be used. The mobile client system 130 of the user or social-networking system 160 may store the user preference for a geo-fence radius for this shared content item 420, and determine that the same geo-fence radius should be used when another content item is shared in similar circumstances. In particular embodiments, social-networking system 160 may use machine learning heuristics to calculate a geo-fence radius for a particular set of circumstances. As an example and not by way of limitation, social-networking system 160 may have a plurality of previous geo-fence radii for a particular user sharing content through social-networking system 160. Based on the geo-fence radii for each content item, and factors associated with the circumstances of each sharing of a shared content item 420, social-networking system 160 may generate an algorithm for predicting the geo-fence radius when the user subsequently shares a shared content item 420. Prediction of a geo-fence radius may be helpful when the associated user with the shared content item 420 is not the sharing user, and therefore social-networking system 160 may not be able to query the associated user for a user-defined geo-fence radius. Based on each user response (e.g. accepting the suggested geo-fence radius or changing it), social-networking system 160 may adjust the algorithm to improve accuracy of geo-fence radius prediction. In particular embodiments, the social-networking system 160 may use a default setting to automatically use the suggested geo-fence radius without explicit user approval each time a content item is shared. In particular embodiments, the user may have to expressly approve each suggested geo-fence radius before social-networking system 160 can use that geo-fence radius for the particular shared content item 420.

In particular embodiments, social-networking system 160 may use a number of factors to calculate a suggested geo-fence radius. As an example and not by way of limitation, social-networking system 160 may consider the affinity of the one or more users receiving access to the shared content with respect to the sharing user. A receiving user who has a high social affinity or social coefficient with respect to the sharing user (e.g. indicating that the two users are close friends) may result in a larger geo-fence radius for the shared content item 420. As another example, social-networking system 160 may consider previous shared content items and their associated geo-fence radii, based on the intended recipients, time of sharing or time that the content was created, or the location of sharing or the location where the content was created. As an example and not by way of limitation, social-networking system 160 may consider if the sharing user is traveling, and use a different geo-fence radius for a traveling user as opposed to a user who is at or near his home. Social-networking system 160 may consider the type of content being shared by the sharing user. This invention contemplates that social-networking system 160 will be able to factor any additional relevant information that is associated with a particular instance of sharing a content item, and use any differences in the relevant information between two or more separate and previous instances of sharing content items as factors in calculating a suggested geo-fence radius for a contemporaneous request to share a content item.

In particular embodiments, the shared content item 420 may be associated with a user who is not the sharing user. In particular embodiments, social-networking system 160 may use privacy settings of the associated user to determine a geo-fence radius. As an example and not by way of limitation, Amy may take and subsequently share a photo of Bob, where Bob is tagged in the photo. Amy's default geo-fence radius for shared photos may be 1 mile, while Bob's default geo-fence radius is 0.5 miles. Social-networking system 160 may determine that Bob's user preferences should be used since he is the user tagged in the photo, and subsequently use 0.5 miles as the geo-fence radius. In particular embodiments, social-networking system 160 may notify the non-sharing user that the sharing user has shared a particular content item, and suggest a geo-fence radius or ask for the non-sharing user to input a geo-fence radius. Social-networking system 160 may use previous geo-fence radii or machine learning as described above to suggest a geo-fence radius to the non-sharing user.

In particular embodiments, the geo-fenced area may be defined as the area comprising a place associated with the content location. As an example and not by way of limitation, user Amy may share a photo from Dolores Park. Social-networking system 160 may determine that the content location of the photo is Dolores Park, and also that the geo-fenced area for the photo comprises Dolores Park. As another example, Amy may have checked-in to Dolores Park through social-networking system 160 five minutes prior to sharing the photo, and social-networking system 160 may thus determine that the photo is also being sent from Dolores Park. In this example, should Amy subsequently leave the park, social-networking system 160 would determine that she is outside the geo-fenced area. In particular embodiments, determining the geo-fenced area to be a place may result in the geo-fenced area not being centered on the content location. As an example and not by way of limitation, Amy may share her photo from the northwest corner of Dolores Park, where her content location is her current geographic location in the northwest corner of Dolores Park, but the geo-fenced area is the entirety of Dolores Park. If she subsequently travels just 50 yards in a northwest direction, she may be outside the park, and thus outside the geo-fenced area. However, if Amy moves in a southeast direction, she may be able to travel several hundred yards before exiting out the southeast corner of Dolores Park. Further description of determining whether the user has left a place, especially an irregularly-shaped place, will be discussed below.

In particular embodiments, social-networking system 160 may determine that the geo-fenced area is a city, county, or any other region wherein the content was created or shared. As an example and not by way of limitation, user Amy may share a photo from Oracle Arena in Oakland, Calif. Social-networking system 160 may determine that the proper geo-fenced area should be Oracle Arena, or the city of Oakland, Calif., or Alameda County, or the state of California. In particular embodiments, social-networking system 160 may expand the geo-fenced area for shared content when the sharing user is travelling. As an example and not by way of limitation, if user Amy lives in Berkeley, Calif., and shares a photo from Oakland, Calif., social-networking system 160 may determine that the geo-fenced area of the photo may be the city of Oakland. Social-networking system 160 may determine that if a larger geo-fenced area was used for this photo (such as Alameda County), Amy may not be leaving the geo-fenced area anytime soon, since she lives in that larger geo-fenced area. However, if user Derek lives in Albany, N.Y. and visits Oakland and shares a photo taken in Oakland, social-networking system 160 may determine that the geo-fenced area for Derek's photo should be the state of California. Social-networking system 160 may determine that there is a high probability that Derek will be leaving California in the near future. As will be discussed in detail below, social-networking system 160 may prefer a geo-fenced area for which the associated user will be leaving in the near future. As discussed above, social-networking system 160 may use machine learning methods to adjust suggested geo-fenced areas to the user, with the additional factor of whether the user is currently travelling.

In particular embodiments, social-networking system 160 may define a geo-fenced area as the area within a particular distance from the place associated with the content location. As an example and not by way of limitation, user Amy may share a photo from Dolores Park, and social-networking system 160 may determine that the content location of the photo should be Dolores Park, not merely Amy's or the photo's geographical location. Social-networking system 160 may specify that the geo-fence radius should be 0.25 miles. Social-networking system 160 may then determine a geo-fenced area comprising all points within 0.25 miles of any part of Dolores Park. Since Dolores Park is not a single point, but comprises a rectangular shape, the geo-fenced area will not resemble a circle, but rather a rounded rectangle centered on Dolores Park.

In particular embodiments, the sharing user may only wish to share the shared content item 420 while a particular user remains in a particular area. In particular embodiments, the particular user is the sharing user, and the particular area is the geo-fenced area comprising the content location. As an example and not by way of limitation, user Amy may share a photo taken at and shared from Dolores Park, San Francisco, Calif., where the photo is shared only with user Christine. Amy may wish for Christine to view the photo, but does not want Christine to have access to the photo indefinitely. Amy may then share the photo where the content location is her current geographic location, the geo-fenced area is a circle with a radius of 0.5 miles centered on her current geographic location, and the associated user is Amy. While social-networking system 160 detects that Amy is within the geo-fenced area comprising a 0.5-mile radius circle, Christine will be able to access the photo on social-networking system 160. However, once social-networking system 160 detects Amy outside the geo-fenced area, social-networking system 160 will expire the sharing of the photo, and Christine will no longer be able to access the photo.

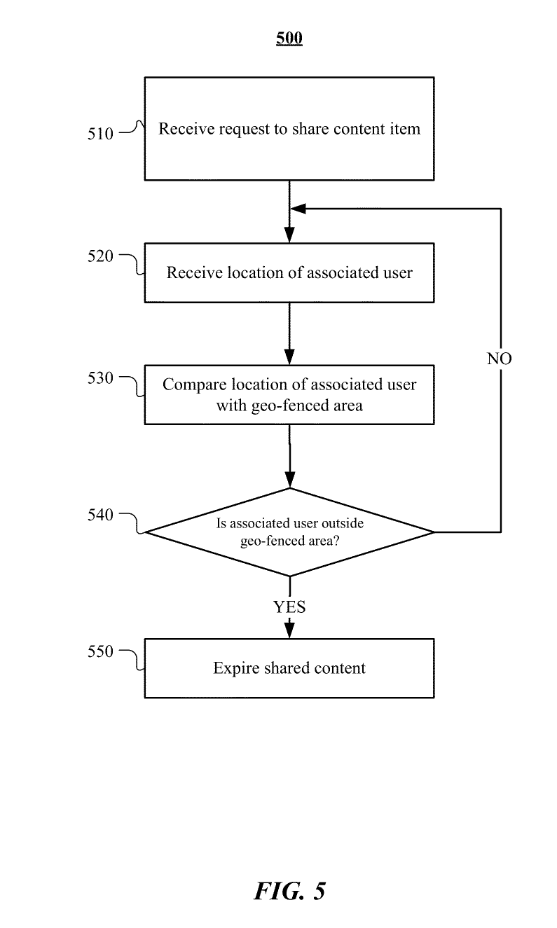

FIG. 5 illustrates an example method for determining if a shared content item with a content location and geo-fenced area and at least one associated user should be expired. At step 510, social-networking system 160 may receive a request from a user to share a content item 420. Social-networking system 160 may determine a content location of the shared content item 420, determine a geo-fenced area for the shared content item 420, and an associated user for the shared content item 420, the associated user currently being within the content location. At step 520, social-networking system 160 may receive a location of the associated user. This location may be an updated location sent by a mobile client system 130 of the associated user to social-networking system 160. This location update may be an update of the geographical location of the associated user, or may be a update of a place that the associated user is at. As an example and not by way of limitation, the associated user may have initially checked-in at place A through social-networking system 160. If the associated user subsequently checks-in at place B which is some distance from place A, social-networking system 160 may update the location of the associated user to be at place B, even though mobile client system 130 of the associated user has not updated its location. At step 530, social-networking system 160 will compare the updated location of the associated user with the geo-fenced area for the shared content item 420. In particular embodiments, if the updated location of the associated user is a place, social-networking system 160 may determine if the place is within the geo-fenced area. At step 540, social-networking system 160 will determine if the associated user's location is outside the geo-fenced area. If the associated user is not outside the geo-fenced area, social-networking system 160 may do nothing with respect to the shared content item 420, until the next updated location of the associated user is received. If the associated user is outside the geo-fenced area, at step 550, social-networking system 160 may determine that the shared content item 420 should be expired.

Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for generating cards for the user including the particular steps of the method of FIG. 5, this disclosure contemplates any suitable method for generating cards for the user including any suitable steps, which may include all, some, or none of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

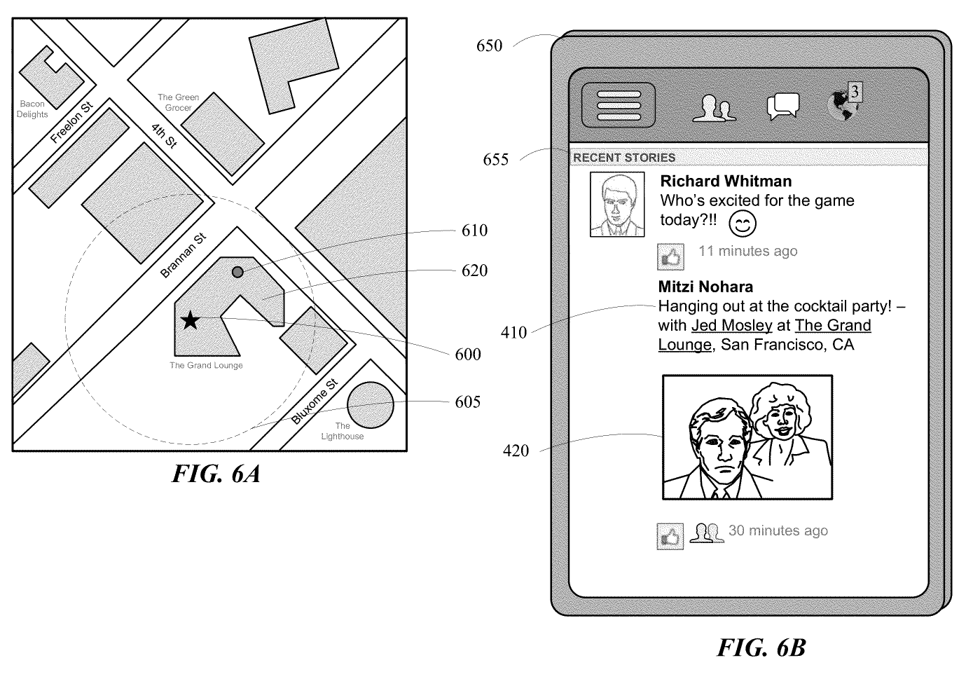

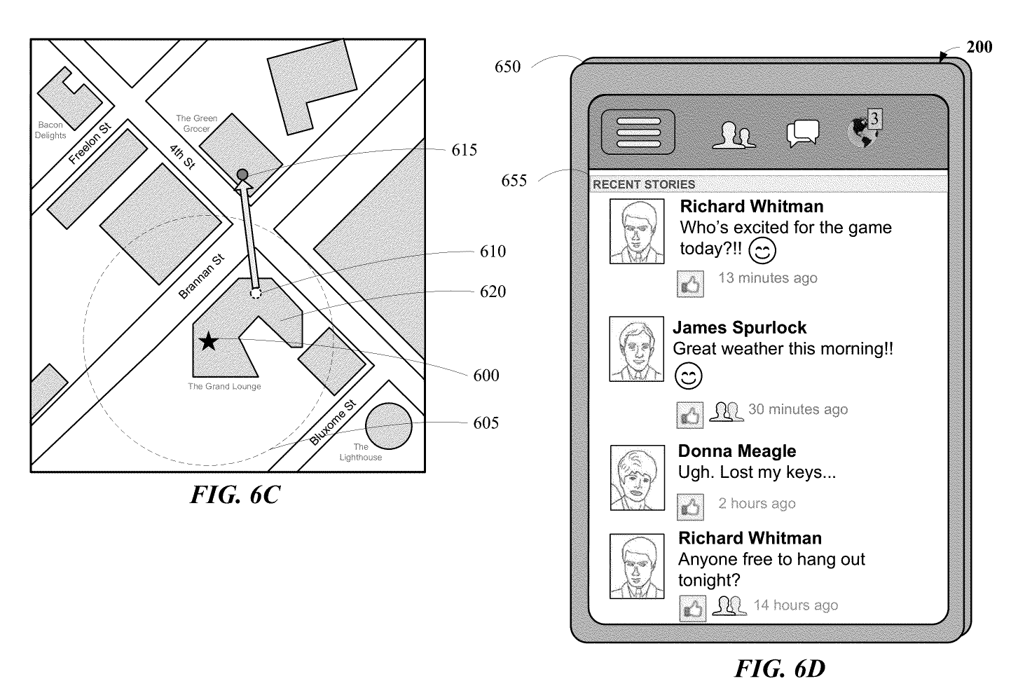

FIGS. 6A-6D illustrate an example of a shared content item remaining visible while the associated user is still within the geo-fenced area. FIG. 6A is a map view showing the location of an associated user 610 and a place 620. FIG. 6A also shows a content location 600, and a geo-fenced area 605 comprising a circle centered on content location 600. In the example of FIG. 6A, the associated user may have sent the photo from content location 600, and subsequently moved to user location 610. In FIG. 6A, the user location 610 is still within the geo-fenced area 605. FIG. 6B is an example depiction of a receiving user's device 650, displaying a newsfeed 655 of social-networking system 160. Within newsfeed 655, the receiving user is able to view a shared content item 420 with an appended status update 410. In FIG. 6C, the user that was previously at user location 610 has moved, and the map view shows an updated user location 615. User location 615 is outside the geo-fenced area 605. Upon detecting that the associated user is outside the geo-fenced area, social-networking system 160 may determine that the shared content item 420 may be expired. FIG. 6D shows the receiving user's device 650 with a newsfeed 655. However, both the shared content item 420 and the associated status update 410 which were visible in the newsfeed in FIG. 6B are no longer visible.

In particular embodiments, the geo-fenced area may be based on a content location which is associated with the location of a user, as described above. Therefore, when the user changes location, the content location also changes location, meaning that the geo-fenced area must also change location. As an example and not by way of limitation, user Amy may share a photo with user Bob, where the associated user is Bob, the current location is Amy's location, and the geo-fenced area is defined as the area within 2 miles of Amy. In this example, so long as Bob remains within 2 miles of Amy, the photo will not expire. If either Amy or Bob move such that the distance between Amy and Bob becomes greater than 2 miles, the photo will expire. As another example, users Ellen and Frank may be travelling together from San Francisco, Calif. to Los Angeles, Calif. While in San Francisco, Ellen may send Frank a video with location-based expiration such that if Ellen and Frank are separated by more than 1 mile, the video will expire. If Ellen and Frank are travelling together (e.g. in the same plane, train, or automobile), then during the extent of their journey to Los Angeles, the video will not expire even though both users have travelled much farther than 1 mile. However, if Ellen and Frank arrive in Los Angeles, and one of the two users (but not the other) subsequently travels to San Diego, Calif., then once the separation between the two users exceeds 1 mile, the video will expire.

In particular embodiments, the receiving user of the shared content item 420 may be determined to be the associated user. Social-networking system 160 may make this determination based on express user input by the sharing user, or by user preferences stored on social-networking system 160. As an example and not by way of limitation, user Amy may send a photo to user Bob, where Amy and Bob are both in Dolores Park, the geo-fenced area is determined to be the boundaries of Dolores Park, and the associated user is Bob (not Amy). In this example, Amy may leave Dolores Park (the geo-fenced area for this photo), and the photo will not expire. Bob may be able to access the photo so long as he remains in Dolores Park, regardless of Amy's location. However, once Bob leaves Dolores Park, social-networking system 160 may expire the sharing of the photo with Bob. In particular embodiments, social-networking system 160 may share the photo with Bob such that he may subsequently return to Dolores Park, and social-networking system 160 may restore Bob's access to the photo. In particular embodiments, once social-networking system 160 has expired the content for a receiving user, subsequent actions of the receiving user will not un-expire the content. In particular embodiments, the receiving user may be at a location distant from the location of the content and the sharing user. Social-networking system 160 may determine in this situation that the content location and the geo-fenced area should be based on the location of the receiving user, not the location of the content or the sharing user. As an example and not by way of limitation, Amy may share a photo with Christine, where the photo was taken in Berkeley, Calif., Amy is currently in Berkeley, but Christine is in San Francisco. Social-networking system 160 may determine that the appropriate content location for this sharing is Christine's location, even though the photo was created in Berkeley and the sharing user is in Berkeley. Therefore, Christine may have access to this photo only while she is in a geo-fenced area within the city of San Francisco (e.g., the city boundaries of San Francisco.)

In particular embodiments, multiple users may be associated with a shared content item 420. As an example and not by way of limitation, a photo may be a group photo depicting several users of social-networking system 160. Social-networking system 160 may determine that all of the users tagged in the photo should be an associated user with respect to that photo. In particular embodiments, social-networking system 160 may determine a single content location and geo-fence are to be used for each of the plurality of associated users. As an example and not by way of limitation, Amy may take a photo of herself, Bob, and Christine, and send the photo to Derek and Ellen. Social-networking system 160 may determine that Amy, Bob, and Christine are to be the associated users with this photo, and determine a content location and a geo-fence area for this photo. In particular embodiments, social-networking system 160 may determine the content location of the photo by the location metadata of the photo at the time the photo was created, or from the location of Amy when she shared the photo. In particular embodiments, social-networking system 160 may determine the locations of each of Amy, Bob, and Christine at the time that Amy shares the photo, and determine that the centroid of these multiple locations should be the content location. In particular embodiments, social-networking system 160 may weight the location of a subset of the multiple users differently than the rest of the users. As an example and not by way of limitation, social-networking system 160 may calculate a centroid of the locations of the three users, but favor Amy's location slightly, so that the content location is determined to be somewhat closer to Amy than the true centroid of the five users.

In particular embodiments, social-networking system 160 may also use a single geo-fenced area for all associated users for a shared content item 420. In particular embodiments, social-networking system 160 may determine a default geo-fence radius to be used when multiple users are associated with a shared content item 420. In particular embodiments, social-networking system 160 may select one user's default settings to be used to calculate a geo-fence area. As an example and not by way of limitation, if one of the associated users has expressly specified particular geo-fence radii to be used, and the rest of the associated users have not, social-networking system 160 may use the specified geo-fence radius of the one user. In particular embodiments, if multiple users have expressed preferences for geo-fencing, social-networking system 160 may take an average of the preferred geo-fence radii. In particular embodiments, if the sharing user has expressly specified a geo-fence radius for the circumstances in which this instant shared content item 420 is being shared, social-networking system 160 may weight the sharing user's preference more heavily than any other users' preferred geo-fence radii. In particular embodiments, social-networking system 160 may select a geo-fence radius based on user preferences with the most restrictive settings, i.e. the preferences which will create the smallest geo-fence radii. In particular embodiments, social-networking system 160 may query each of the associated users and ask for their input on a geo-fence radius for the shared content item 420. In particular embodiments, social-networking system 160 may provide the associated users with a set of at least one set distance to be used. As an example and not by way of limitation, social-networking system 160 may ask each user to choose a distance of A) 0.25 miles; B) 0.5 miles; or C) 1.0 mile. Social-networking system 160 may collect user input, and select the option that is most popular. In particular embodiments, social-networking system 160 may allow each associated user to express their preferred geo-fence distance, then take the shortest distance selected. As an example and not by way of limitation, if social-networking system 160 asks three associated users to select a geo-fence radius, and the three responses are 0.5 miles, 2 miles, and 10 miles, social-networking system 160 may select 0.5 miles. In particular embodiments, social-networking system 160 may take the average of the expressed distances to determine the geo-fence radius. In the example above, social-networking system 160 may determine a geo-fence radius of 4.17 miles.

In particular embodiments, social-networking system 160 may determine individual content locations and geo-fenced areas for each associated user, or for subsets of associated users. As an example and not by way of limitation, Amy may take a photo depicting herself, Bob, Christine, and Derek, and share the photo through social-networking system 160. Social-networking system 160 may calculate individual content locations for each user, wherein each user's content location comprises the user's location at the time the photo was shared. Each user's geo-fence radius may be individually determined by each user's individual preferences. In particular embodiments, social-networking system 160 may determine that a subset of users should share a common content location and geo-fence radius, while the remaining users are calculated separately. As an example and not by way of limitation, social-networking system 160 may determine that when a photo is shared tagging Amy, Bob, Christine, and Derek, Christine and Derek are near each other, and Amy and Bob are near each other. Social-networking system 160 may then calculate one content location and geo-fence radius for Amy and Bob, and a second, separate content location and geo-fence radius for Christine and Derek.

In particular embodiments, social-networking system 160 may determine if a shared content item 420 should be expired based on how many of the multiple associated users are detected leaving their respective geo-fenced areas. In particular embodiments, social-networking system 160 may expire the shared content item 420 when any one of the multiple associated users leaves his or her respective geo-fenced area. In particular embodiments, social-networking system 160 may determine that the shared content item 420 is expired when a certain fraction (e.g. 1/2) of the associated users have left their respective geo-fence locations. In particular embodiments, social-networking system 160 may only expire the shared content item 420 when all of the associated users have left their geo-fenced areas. In particular embodiments, once an associated user leaves his respective geo-fenced area, social-networking system 160 may consider the associated user to have permanently left their geo-fenced area. In particular embodiments, social-networking system 160 may detect that an associated user has subsequently re-entered her respective geo-fenced area, and thus treat that user as no longer having left. As an example and not by way of limitation, Amy may share a photo with associated users Amy, Bob, and Christine, where each associated user has their own geo-fenced area A1, B1, and C1. Social-networking system 160 may be configured to expire the photo when all of the users have left their respective geo-fenced areas. Amy may leave A1, the Bob may leave B1. However, before Christine leaves C1, Amy may re-enter A1. In particular embodiments, social-networking system 160 may treat Amy as having left A1 for good, and thus when Christine leaves C1, determine that the conditions for expiring the photo have been met. In particular embodiments, social-networking system 160 may treat Amy as no longer having left A1, and thus when Christine leaves C1, the content is still not expired because not all associated users have left their geo-fenced areas. In this example, social-networking system 160 would expire the content if Amy left A1, and Bob and Christine had not re-entered their respective geo-fenced areas in the meantime.

In particular embodiments, a user may share a shared content item 420 with different geo-fenced areas for different receiving users. Social-networking system 160 may then expire the shared content items at different times to the different receiving users. As an example and not by way of limitation, Amy may share a photo depicting herself to Bob and Christine. The content location of the photo may be location A1, and the associated user may be Amy. Social-networking system 160 may determine that the geo-fenced area for this photo with respect to Bob is a circle with a radius of 0.5 miles, while the geo-fenced area for this photo with respect to Christine is the area of the City of San Francisco. Social-networking system 160 may specify different geo-fence radii for different users based on the social affinity or coefficient of the receiving user with respect to the sharing user. In the example above, social-networking system 160 may determine that Christine is a very close friend of Amy, while Bob is not as close to Amy. Therefore, the shared photo may have a larger geo-fenced area with respect to Christine. Social-networking system 160 may calculate different geo-fenced areas automatically, or social-networking system 160 may present the sharing user with the option to specify different geo-fenced areas for different receiving users. In the example above, Amy may have also shared the photo publicly on her wall on social-networking system 160, but with a geo-fence radius corresponding to the boundaries of Dolores Park to all other users. In this example, all users of social-networking system 160 authorized to access content shared by Amy may access this shared photo. Once Amy leaves Dolores Park, only Bob and Christine may have access to the photo. Once Amy has left the 0.5-mile radius circle from the content location, only Christine may have access to the photo. Once Amy leaves San Francisco, no user may have access to the shared photo.

In particular embodiments, social-networking system 160 may use a variety of methods to expire the sharing of shared content item 420. In particular embodiments, if the sharing user shared the content as a post to a newsfeed, as in the example of FIGS. 6B and 6D, then social-networking system 160 may subsequently hide that post from the newsfeeds of users previously authorized to access the shared content item 420. In particular embodiments, social-networking system 160 may delete the shared content item 420 entirely from the social-networking system, so that social-networking system 160 does not have any copy of the shared content item 420. In particular embodiments, expiration of the shared content item 420 from social-networking system 160 may additionally comprise deleting the copy of the shared content item 420 stored on the mobile client system 130 of the sharing user as well. As an example and not by way of limitation, when a shared photo is expired, social-networking system 160 may remove all posts of the photo from newsfeeds of other users on social-networking system 160; may delete any stored copies of the shared photo from social-networking system 160; and notify the mobile client system 130 belonging to the sharing user (and from which the shared photo was sent to social-networking system 160) that the stored copy of the shared photo should also be deleted from the mobile client system 130. The option to delete copies of shared content item 420 stored on social-networking system 160 and mobile client system 130 of the sharing user may be determined by user preference.

In particular embodiments, if the content was sent as a notification to a receiving user, social-networking system 160 may delete the notification from the device of the receiving user. Social-networking system 160 may push an instruction to a mobile client system 130 of the receiving user to delete or hide the notification. As an example and not by way of limitation, user Amy may share a photo with user Bob through a messaging interface of social-networking system 160. Social-networking system 160 may send a notification to the mobile client system 130 of Bob comprising a notification that Amy has shared a photo. However, before Bob has a chance to interact with the notification or access the photo, Amy, as the associated user of the shared photo, may leave the geo-fenced area. Subsequently, social-networking system 160 may push instructions to Bob's mobile client system 130 to hide or delete the notification. If Bob later views his mobile client system 130, there would be no indication that Amy had shared a photo.

In particular embodiments, the sharing user may send the shared content item 420 in a message to the receiving user, who then views the message and the shared content item 420. If the shared content item 420 subsequently expires, social-networking system 160 may push instructions to the mobile client systems 130 which accessed the shared content item 420, instructing the mobile client systems 130 to hide or delete the shared content item. As an example and not by way of limitation, Amy may send a photo to Bob in an email. Bob may open the email on his mobile client system 130 and view the photo. If the photo subsequently expires, social-networking system 160 may send instructions to Bob's mobile client system 130 instructing it to hide or delete the photo. If Bob subsequently tries to access the email and photo, the entire email may be deleted, or the photo may be deleted from the email. In particular embodiments, social-networking system 160 may send instructions that the shared content item 420 be deleted from the receiving user's device, and leave a message informing them that the shared content item is no longer accessible. In particular embodiments, the shared content item may not be sent to a mobile client system 130 of a receiving user, but rather stored on social-networking system 160 and viewable by the receiving user through their mobile client system 130 accessing social-networking system 160. If this content subsequently expires, the shared content may no longer be visible to the mobile client system 130 of the receiving user. This invention contemplates any other means of making content previously accessible by one or more users no longer accessible.

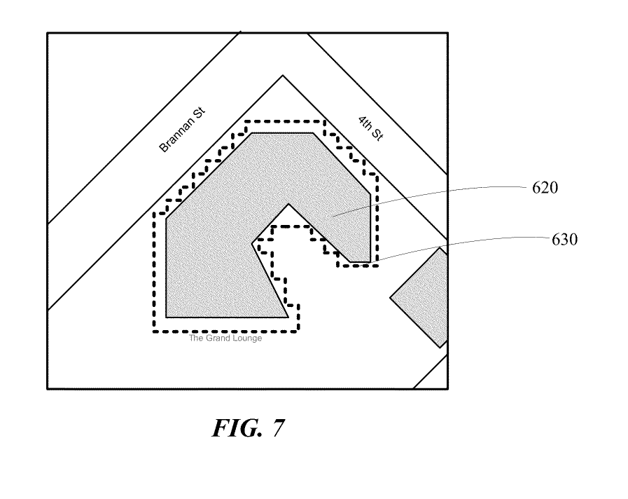

In particular embodiments, the content location or geo-fenced area for shared content item 420 may be a place, wherein the content location or geo-fenced areas are defined by the physical boundaries of the place. FIG. 7 illustrates an example of a place 620 which has an irregularly-shaped boundary. For such places, social-networking system 160 may model the place as a polygon. The polygon may define an area that circumscribes or closely surrounds the place. A bounding box may be constructed around the polygon, and then a N×N grid of sample points may be superimposed over the bounding box, where N is any suitable positive integer. Sample points located outside the polygon are discarded, and sample points located within or on the border of the polygon are kept. This results in a rough approximation boundary 630 of the boundaries of the place. The accuracy of the approximation boundary 630 may depend on the resolution of the grid of sample points used. In particular embodiments, social-networking system 160 may define a geo-fenced area as the area within the approximation boundary 630. In particular embodiments, social-networking system 160 may use the approximation boundary 630 as the content location, and specify a geo-fenced area defined as the area within a particular distance from any part of the approximation boundary 630. Further disclosure of determining the location of a place represented as a polygon and mapping to a sample grid is disclosed in U.S. patent application Ser. No. 14/22,0493, filed 20 Mar. 2014,

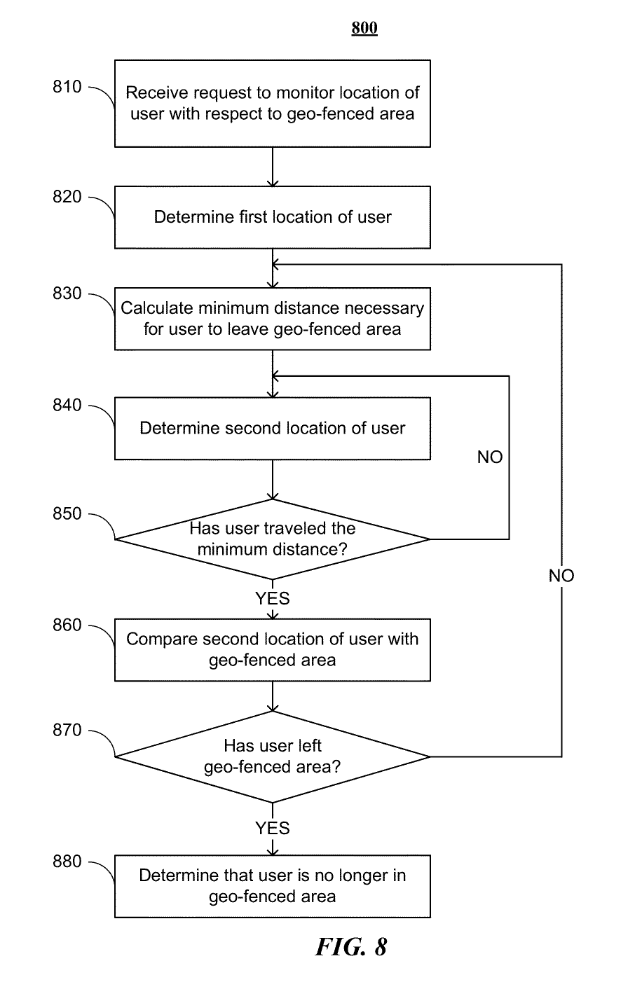

FIG. 8 illustrates an example method of determining whether a user currently in a geo-fenced area has left the geo-fenced area, based at least in part on the distance travelled by the user. At step 810, social-networking system 160 may receive a request to monitor the location of a user with respect to a particular geo-fenced area. At step 820, social-networking system 160 may determine a first location of the user. The first location may be compared against the location of the geo-fenced area. In particular embodiments, the locations corresponding to the geo-fenced area may be determined as described above by generating a grid of sample location points and discarding sample location points outside the polygon defining the place. At step 830, once the first location of the user is determined, social-networking system 160 may determine the minimum necessary distance that the user must travel in any direction before the user could leave the geo-fenced area. At step 840, social-networking system 160 may determine a second location of the user. The second location may be provided to social-networking system 160 through a mobile client system 130 of the user or by any other suitable methods. At step 850, social-networking system 160 will determine the distance the user has travelled from the first location to the second location, and compare that distance to the minimum necessary distance calculated in step 830. If the user has not travelled the minimum necessary distance, social-networking system 160 may assume that the user has therefore not left the geo-fenced area, and return to step 840, to await a new location of the user. If the user has travelled more than the minimum necessary distance, then social-networking system 160 may compare the second location against the location of the geo-fenced area. If the second location is outside the defined location boundary of the geo-fenced area, then at step 880, social-networking system 160 may determine that the user has left the geo-fenced area, and perform any necessary tasks responsive to this determination, e.g. expire any content that was associated with this user and geo-fenced area. If social-networking system 160 determines that the user is still within the geo-fenced place (e.g. the user was at the edge of the approximation boundary 630, then travelled the necessary distance to leave the geo-fenced area, but instead travelled toward the center of the place), then social-networking system 160 may return to step 830 and calculate a new minimum necessary distance for the user to leave the place from the second location. The process would begin again from the point of step 830.

Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method for generating cards for the user including the particular steps of the method of FIG. 8, this disclosure contemplates any suitable method for generating cards for the user including any suitable steps, which may include all, some, or none of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8.

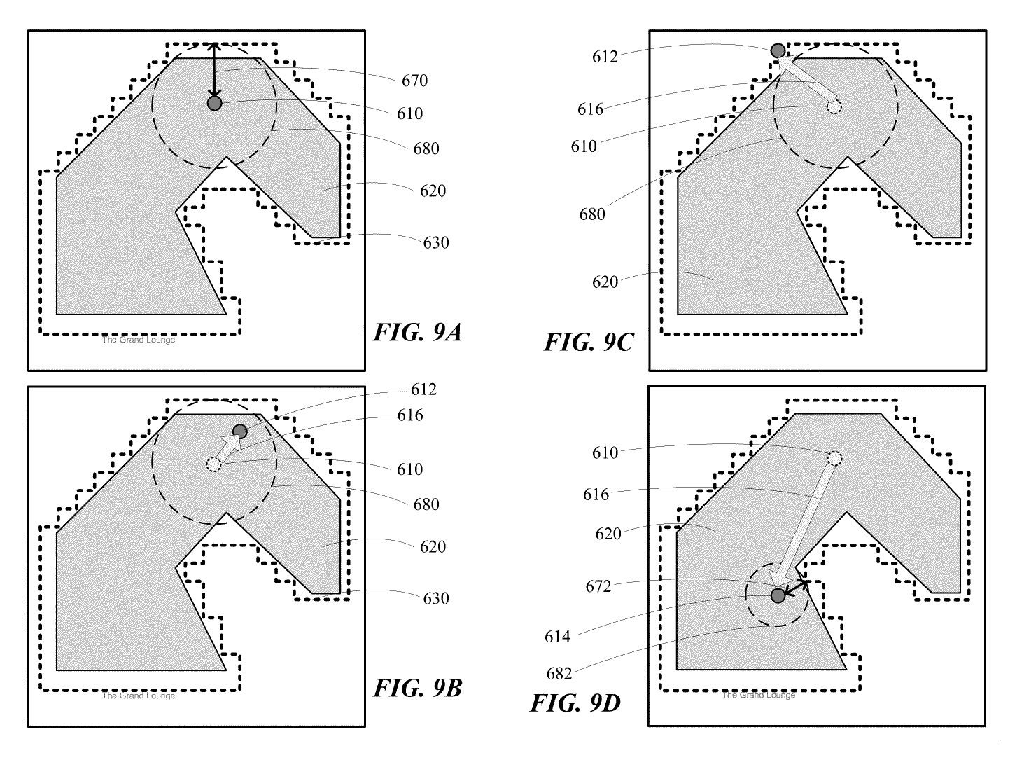

FIGS. 9A-9D illustrates an example map view of the method described in FIG. 8. In FIG. 9A, the user is in a place 620, with a defined approximation boundary 630. The first location of the user may be determined to be location 610. Social-networking system 160 may calculate a minimum distance 670 necessary for the user to leave the approximation boundary 630, in effect creating a pseudo-geo-fenced area 680 centered on the user's first location 610. In FIG. 9B, the user may have moved to a second location 612. Social-networking system 160 may calculate the distance traveled 616 from the first location 610 to the second location 612. In the example of FIG. 9B, distance 616 may be less than the distance 670. Therefore, social-networking system 160 may refrain from performing any further actions and may wait for a new location to be determined. In FIG. 9C, the user may have travelled to a second location 612, where the distance 616 between the first location 610 and second location 612 is greater than the minimum distance 670. Social-networking system 160 may then determine if second location 612 is outside the geo-fenced area comprising the approximation boundary 630. In the example of FIG. 9C, the user is now outside the approximation boundary 630, so social-networking system 160 may determine that the user has left the geo-fenced area. In the example of FIG. 9D, the user has also moved to a second location 612 such that the distance travelled 616 is greater than the minimum distance 670. In FIG. 9D, the social-networking system 160 may compare the second location 612 against the approximation boundary 630 and determine that the user has not left the geo-fenced location. Social-networking system 160 may then calculate a new minimum distance 672 which must be traversed by the user in order for the user to leave from the second location.

In particular embodiments, a sharing user may also desire that a shared content item 420 be expired by social-networking system 160 after a certain amount of time has elapsed, in addition to location-based expiration. As an example and not by way of limitation, user Amy may share a photo to user Bob, with a location-based expiration using methods described above such that if Amy leaves San Francisco, the photo will expire. However, Amy may be uncertain when she will be next be leaving San Francisco, and may want to the photo to expire sooner rather than later. Amy may then specify that the photo may expire when she leaves San Francisco OR after one day, whichever occurs sooner. In this example, social-networking system 160 would then monitor Amy's location throughout the day after she shares the photo to determine if she has left San Francisco. If she does at any point, the photo will be expired. If 24 hours have passed since Amy shared the photo and Amy still has not left, social-networking system 160 may still expire the photo. In particular embodiments, the shared content item 420 may expire when the specified time period has elapsed since the time that the content item was shared on social-networking system 160. In particular embodiments, the time-based expiration may act as a fail-safe in case the social-networking system 160 is unable to determine if the shared content item 420 has expired due to a location-based expiration. As an example and not by way of limitation, user Amy may share a photo with user Bob, with a location-based expiration configured so that if Amy leaves San Francisco, the photo expires. The photo may also have a time-based expiration of 4 hours which is reset if social-networking system 160 detects that Amy is still in San Francisco. If at any point Amy is detected leaving San Francisco, the photo is expired as described above. However, social-networking system 160 may be unable to determine Amy's location. As an example and not by way of limitation, Amy may have turned off her mobile client system 130, may be in an area with poor network connectivity such that social-networking system 160 is unable to receive a location update from Amy's mobile client system 130, or there may be any other circumstance in which social-networking system 160 cannot determine Amy's location. In this situation, if more than 4 hours have elapsed from the last location update from Amy, social-networking system 160 will trigger the time-based expiration and expire the photo. As another example and not by way of limitation, if social-networking system 160 cannot determine Amy's location for three hours, then Amy turns her mobile client system 130 back on and social-networking system 160 detects her location as still in San Francisco, social-networking system 160 may reset the time-based expiration back to four hours.

In particular embodiments, the time-based expiration of content may be determined by social-networking system 160. If social-networking system 160 determines either a time-based or location-based expiration has occurred, social-networking system 160 may push a notification or other information to any mobile client system 130 that has received access to the shared content item 420. In particular embodiments, a receiving user's mobile client system 130 which has access to a shared content item 420 may not be configured to receive data pushed by social-networking system 160, or may be unable to receive information pushed by social-networking system 160 at a particular time. In particular embodiments, the time-based expiration of content may be determined by the mobile client system 130 of the receiving user, while the location-based expiration may still occur at social-networking system 160. As an example and not by way of limitation, in the same example above with Amy sending a photo with a time-based expiration of four hours, receiving user Bob may access the photo at his mobile client system 130, then subsequently lose connection to social-networking system 160. For example, Bob may receive this picture, and then board a cross-country flight with no Internet connectivity. If the time-based expiration is handled by social-networking system 160, then even after four hours, social-networking system 160 will not be able to contact Bob's mobile client system 130 to inform the device that the photo has not expired. Determining time-based expiration on the receiving user's device would mean that in this example, Bob's mobile client system 130, having lost connectivity to social-networking system 160 for four hours, would automatically expire the content. If Bob subsequently lands in New York City, reestablishes a connection to social-networking system 160, and social-networking system 160 has determined that Amy has never left San Francisco the entire time, social-networking system 160 may re-share the photo with Bob.

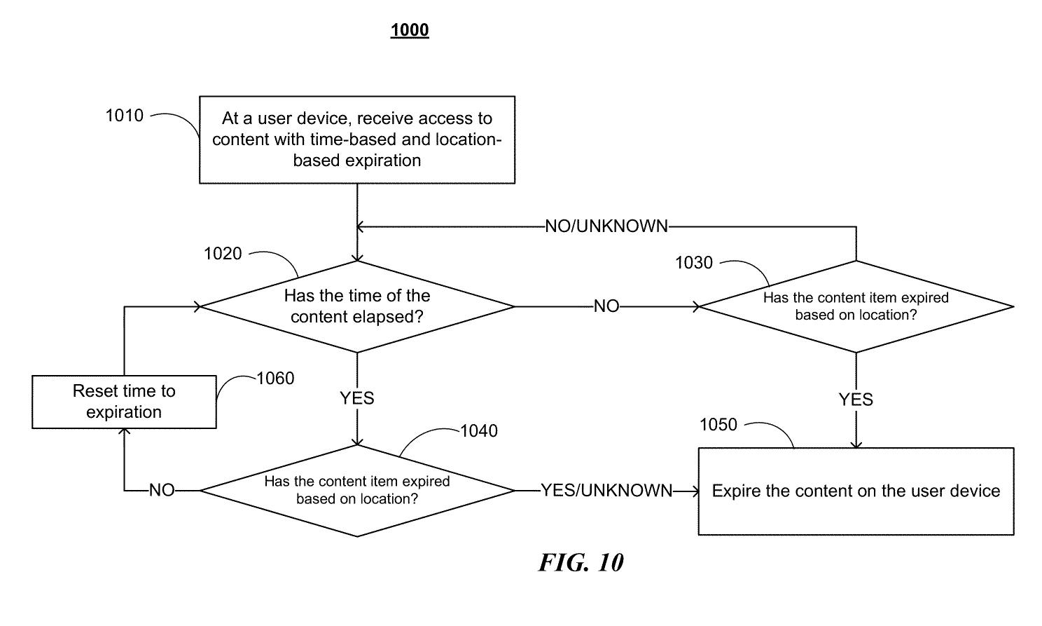

FIG. 10 illustrates an example method for determining at a receiving user's device if a shared content item 420 should be expired based on both a time-based expiration and a location-based expiration, where the time may be reset based on location information. At step 1010, the receiving user's device may receive access to a shared content item 420 which has both a time-based expiration and a location-based expiration. The time-based expiration may comprise a specified lifetime for the shared content item 420. At step 1020, the receiving user's device may determine if the lifetime of the shared content item 420 has elapsed. If the lifetime has not elapsed, at step 1030, the receiving user's device may request an update from social-networking system 160 of whether the location-based expiration has occurred. If social-networking system 160 knows that the associated user has not left the geo-fenced area for this particular shared content item 420, or else is unable to determine a location of the associated user, the process may determine that the shared content item 420 does not have to be expired, and return to step 1020. If location-based expiration has occurred, then social-networking system 160 will send that information to the receiving user's device at step 1050 and the receiving user's device will expire the content. If at step 1020 the lifetime of the shared content item 420 has elapsed, then at step 1040, the receiving user's device may request an update from social-networking system 160 of whether location-based expiration has occurred. The possible results at step 1040 are different than the results from the similar request made by the receiving user's device at step 1030. At step 1040, if social-networking system 160 determines that the associated user has not left the geo-fenced area, then at step 1060, the receiving user's device may reset the lifetime for the shared content item 420, and return to step 1020. At step 1040, if social-networking system 160 has determined that location-based expiration has occurred, or is unable to determine if location-based expiration has occurred (i.e. social-networking system 160 is unable to determine a location of an associated user), then at step 1050, the receiving user's device will expire the content based on either the location-based expiration or the time-based expiration. In particular embodiments, the receiving user's device may not reset the lifetime of the shared content item, and at step 1040, may automatically proceed to expire the content item at step 1050. In this embodiment, once step 1040 is reached, the shared content item 420 must expire by either the location-based expiration or the time-based expiration.

Particular embodiments may repeat one or more steps of the method of FIG. 10, where appropriate. Although this disclosure describes and illustrates particular steps of the method of FIG. 10 as occurring in a particular order, this disclosure contemplates any suitable steps of the method of FIG. 10 occurring in any suitable order. Moreover, although this disclosure describes and illustrates an example method for generating cards for the user including the particular steps of the method of FIG. 10, this disclosure contemplates any suitable method for generating cards for the user including any suitable steps, which may include all, some, or none of the steps of the method of FIG. 10, where appropriate. Furthermore, although this disclosure describes and illustrates particular components, devices, or systems carrying out particular steps of the method of FIG. 10, this disclosure contemplates any suitable combination of any suitable components, devices, or systems carrying out any suitable steps of the method of FIG. 10.

In particular embodiments, social-networking system 160 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 170 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 160 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part a the history of the user's actions. Coefficients may be used to predict any number of actions, which may be within or outside of the online social network. As an example and not by way of limitation, these actions may include various types of communications, such as sending messages, posting content, or commenting on content; various types of a observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 160 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 160 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 160 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 160 may calculate a coefficient based on a user's actions. Social-networking system 160 may monitor such actions on the online social network, on a third-party system 170, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, social-networking system 160 may calculate a coefficient based on the user's actions with particular types of content. The content may be associated with the online social network, a third-party system 170, or another suitable system. The content may include users, profile pages, posts, news stories, headlines, instant messages, chat room conversations, emails, advertisements, pictures, video, music, other suitable objects, or any combination thereof. Social-networking system 160 may analyze a user's actions to determine whether one or more of the actions indicate an affinity for subject matter, content, other users, and so forth. As an example and not by way of limitation, if a user may make frequently posts content related to “coffee” or variants thereof, social-networking system 160 may determine the user has a high coefficient with respect to the concept “coffee”. Particular actions or types of actions may be assigned a higher weight or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 160 may calculate a coefficient based on the type of relationship between particular objects. Referencing the social graph 200, social-networking system 160 may analyze the number or type of edges 206 connecting particular user nodes 202 and concept nodes 204 when calculating a coefficient. As an example and not by way of limitation, user nodes 202 that are connected by a spouse-type edge (representing that the two users are married) may be assigned a higher coefficient than a user nodes 202 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights or the ratings of the user's actions with respect to calculating the coefficient for that object. As an example and not by way of limitation, if a user is tagged in first photo, but merely likes a second photo, social-networking system 160 may determine that the user has a higher coefficient with respect to the first photo than the second photo because having a tagged-in-type relationship with content may be assigned a higher weight or rating than having a like-type relationship with content. In particular embodiments, social-networking system 160 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 160 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 200. As an example and not by way of limitation, social-graph entities that are closer in the social graph 200 (i.e., fewer degrees of separation) may have a higher coefficient than entities that are further apart in the social graph 200.

In particular embodiments, social-networking system 160 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 130 of the user). A first user may be more interested in other users or concepts that are closer to the first user. As an example and not by way of limitation, if a user is one mile from an airport and two miles from a gas station, social-networking system 160 may determine that the user has a higher coefficient for the airport than the gas station based on the proximity of the airport to the user.

In particular embodiments, social-networking system 160 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 160 may provide information that is relevant to user's interests and current circumstances, increasing the likelihood that they will find such information of interest. In particular embodiments, social-networking system 160 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 160 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 160 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 170 (e.g., via an API or other communication channel), or from another suitable system. In response to the request, social-networking system 160 may calculate the coefficient (or access the coefficient information if it has previously been calculated and stored). In particular embodiments, social-networking system 160 may measure an affinity with respect to a particular process. Different processes (both internal and external to the online social network) may request a coefficient for a particular object or set of objects. Social-networking system 160 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

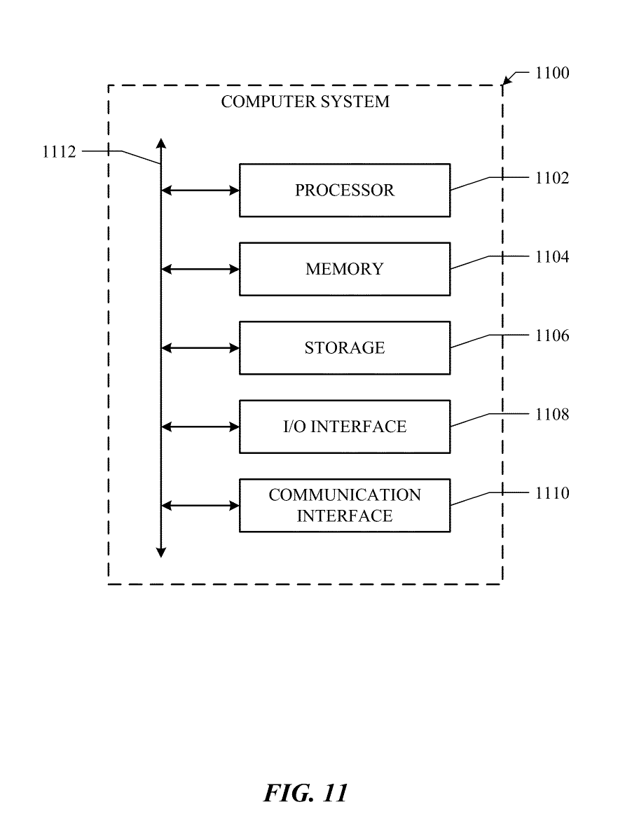

FIG. 11 illustrates an example computer system 1100. In particular embodiments, one or more computer systems 1100 perform one or more steps of one or more methods described or illustrated herein. In particular embodiments, one or more computer systems 1100 provide functionality described or illustrated herein. In particular embodiments, software running on one or more computer systems 1100 performs one or more steps of one or more methods described or illustrated herein or provides functionality described or illustrated herein. Particular embodiments include one or more portions of one or more computer systems 1100. Herein, reference to a computer system may encompass a computing device, and vice versa, where appropriate. Moreover, reference to a computer system may encompass one or more computer systems, where appropriate.

This disclosure contemplates any suitable number of computer systems 1100. This disclosure contemplates computer system 1100 taking any suitable physical form. As example and not by way of limitation, computer system 1100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1100 may include one or more computer systems 1100; be unitary or distributed; span multiple locations; span multiple machines; span multiple data centers; or reside in a cloud, which may include one or more cloud components in one or more networks. Where appropriate, one or more computer systems 1100 may perform without substantial spatial or temporal limitation one or more steps of one or more methods described or illustrated herein. As an example and not by way of limitation, one or more computer systems 1100 may perform in real time or in batch mode one or more steps of one or more methods described or illustrated herein. One or more computer systems 1100 may perform at different times or at different locations one or more steps of one or more methods described or illustrated herein, where appropriate.

In particular embodiments, computer system 1100 includes a processor 1102, memory 1104, storage 1106, an input/output (I/O) interface 1108, a communication interface 1110, and a bus 1112. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1102 includes hardware for executing instructions, such as those making up a computer program. As an example and not by way of limitation, to execute instructions, processor 1102 may retrieve (or fetch) the instructions from an internal register, an internal cache, memory 1104, or storage 1106; decode and execute them; and then write one or more results to an internal register, an internal cache, memory 1104, or storage 1106. In particular embodiments, processor 1102 may include one or more internal caches for data, instructions, or addresses. This disclosure contemplates processor 1102 including any suitable number of any suitable internal caches, where appropriate. As an example and not by way of limitation, processor 1102 may include one or more instruction caches, one or more data caches, and one or more translation lookaside buffers (TLBs). Instructions in the instruction caches may be copies of instructions in memory 1104 or storage 1106, and the instruction caches may speed up retrieval of those instructions by processor 1102. Data in the data caches may be copies of data in memory 1104 or storage 1106 for instructions executing at processor 1102 to operate on; the results of previous instructions executed at processor 1102 for access by subsequent instructions executing at processor 1102 or for writing to memory 1104 or storage 1106; or other suitable data. The data caches may speed up read or write operations by processor 1102. The TLBs may speed up virtual-address translation for processor 1102. In particular embodiments, processor 1102 may include one or more internal registers for data, instructions, or addresses. This disclosure contemplates processor 1102 including any suitable number of any suitable internal registers, where appropriate. Where appropriate, processor 1102 may include one or more arithmetic logic units (ALUs); be a multi-core processor; or include one or more processors 1102. Although this disclosure describes and illustrates a particular processor, this disclosure contemplates any suitable processor.

In particular embodiments, memory 1104 includes main memory for storing instructions for processor 1102 to execute or data for processor 1102 to operate on. As an example and not by way of limitation, computer system 1100 may load instructions from storage 1106 or another source (such as, for example, another computer system 1100) to memory 1104. Processor 1102 may then load the instructions from memory 1104 to an internal register or internal cache. To execute the instructions, processor 1102 may retrieve the instructions from the internal register or internal cache and decode them. During or after execution of the instructions, processor 1102 may write one or more results (which may be intermediate or final results) to the internal register or internal cache. Processor 1102 may then write one or more of those results to memory 1104. In particular embodiments, processor 1102 executes only instructions in one or more internal registers or internal caches or in memory 1104 (as opposed to storage 1106 or elsewhere) and operates only on data in one or more internal registers or internal caches or in memory 1104 (as opposed to storage 1106 or elsewhere). One or more memory buses (which may each include an address bus and a data bus) may couple processor 1102 to memory 1104. Bus 1112 may include one or more memory buses, as described below. In particular embodiments, one or more memory management units (MMUs) reside between processor 1102 and memory 1104 and facilitate accesses to memory 1104 requested by processor 1102. In particular embodiments, memory 1104 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1104 may include one or more memories 1104, where appropriate. Although this disclosure describes and illustrates particular memory, this disclosure contemplates any suitable memory.

In particular embodiments, storage 1106 includes mass storage for data or instructions. As an example and not by way of limitation, storage 1106 may include a hard disk drive (HDD), a floppy disk drive, flash memory, an optical disc, a magneto-optical disc, magnetic tape, or a Universal Serial Bus (USB) drive or a combination of two or more of these. Storage 1106 may include removable or non-removable (or fixed) media, where appropriate. Storage 1106 may be internal or external to computer system 1100, where appropriate. In particular embodiments, storage 1106 is non-volatile, solid-state memory. In particular embodiments, storage 1106 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1106 taking any suitable physical form. Storage 1106 may include one or more storage control units facilitating communication between processor 1102 and storage 1106, where appropriate. Where appropriate, storage 1106 may include one or more storages 1106. Although this disclosure describes and illustrates particular storage, this disclosure contemplates any suitable storage.

In particular embodiments, I/O interface 1108 includes hardware, software, or both, providing one or more interfaces for communication between computer system 1100 and one or more I/O devices. Computer system 1100 may include one or more of these I/O devices, where appropriate. One or more of these I/O devices may enable communication between a person and computer system 1100. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1108 for them. Where appropriate, I/O interface 1108 may include one or more device or software drivers enabling processor 1102 to drive one or more of these I/O devices. I/O interface 1108 may include one or more I/O interfaces 1108, where appropriate. Although this disclosure describes and illustrates a particular I/O interface, this disclosure contemplates any suitable I/O interface.

In particular embodiments, communication interface 1110 includes hardware, software, or both providing one or more interfaces for communication (such as, for example, packet-based communication) between computer system 1100 and one or more other computer systems 1100 or one or more networks. As an example and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1110 for it. As an example and not by way of limitation, computer system 1100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1100 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1100 may include any suitable communication interface 1110 for any of these networks, where appropriate. Communication interface 1110 may include one or more communication interfaces 1110, where appropriate. Although this disclosure describes and illustrates a particular communication interface, this disclosure contemplates any suitable communication interface.

In particular embodiments, bus 1112 includes hardware, software, or both coupling components of computer system 1100 to each other. As an example and not by way of limitation, bus 1112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1112 may include one or more buses 1112, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
by one or more computing devices, receiving a request to share with a first user a content item associated with a second user;
by one or more computing devices, determining a content location for the content item;
by one or more computing devices, determining a geo-fenced area for the content item, wherein the geo-fenced area comprises the content location;
by one or more computing devices, sharing the content item with the first user as requested;
by one or more computing devices, if the second user moves to a location outside the geo-fenced area, determining whether to terminate the sharing of the content item.

2. The method of claim 1, wherein the content item comprises:
a photo;
a video;
a sound recording;
a post;
a text; or
a link to a web page.

3. The method of claim 1, wherein the request to share the content item with the first user comprises a request to:
send a message to the first user;
post the content item to a social-networking system;
send a Short Message Service (SMS) message to the first user;
send an instant message (IM) to the first user;
send a notification to the first user;
post a status update on the social-networking system; or
send an e-mail to the first user.

4. The method of claim 1, wherein the request is from the second user.

5. The method of claim 1, wherein the second user is tagged in the content item.

6. The method of claim 1, wherein the content location is based at least in part on a location indicated by metadata associated with the content item.

7. The method of claim 1, wherein:
the request indicates a current location of the second user; and
the content location is based at least in part on the current location of the second user.

8. The method of claim 1, wherein the content location is determined by user input provided by the second user.

9. The method of claim 1, wherein the geo-fenced area comprises a circle with a particular radius centered on the content location.

10. The method of claim 9, wherein the particular radius is defined by the second user.

11. The method of claim 9, wherein the particular radius is based at least in part on a privacy setting of the second user.

12. The method of claim 1, wherein the content location is associated with a place.

13. The method of claim 12, wherein the geo-fenced area is based at least in part on boundaries of the place.

14. The method of claim 12, wherein the geo-fenced area is based at least in part on a distance between the content location and the boundaries of the place.

15. The method of claim 1, further comprising:
associating the content item with a lifetime, the lifetime being a particular period of time as measured from a time of the request; and
after the lifetime has passed, if the sharing of the content item has not yet terminated, then terminating the sharing of the content item.

16. The method of claim 1, wherein the second user is the first user.

17. The method of claim 1, wherein terminating the sharing of the content item comprises:
deleting the content item from a social-networking system;
causing the content item to be deleted from a computing device of the first user;
causing the content item to become hidden on a computing device of the first user; or
causing a notification sent to the first user to be deleted from a computing device of the first user.

18. The method of claim 1, wherein the content location comprises a location of a user, and the content location and geo-fenced area are updated in response to a location update of the user.

19. A system comprising:
one or more processors; and
a memory coupled to the processors comprising instructions executable by the processors, the processors operable when executing the instructions to:
receive a request to share with a first user a content item associated with a second user;
determine a content location for the content item;
determine a geo-fenced area for the content item, wherein the geo-fenced area comprises the content-location;
share the content item with the first user as requested;
if the second user moves to a location outside the geo-fenced area, determine whether to terminate the sharing of the content item.

20. A non-transitory, computer-readable storage media embodying software that is operable when executed to:
receive a request to share with a first user a content item associated with a second user;
determine a content location for the content item;
determine a geo-fenced area for the content item, wherein the geo-fenced area comprises the content-location;
share the content item with the first user as requested;
if the second user moves to a location outside the geo-fenced area, determine whether to terminate the sharing of the content item.
